(19) United States
(12) Patent Application Publication
(10) Pub. No.: US 2006/0112145 A1
(43) Pub. Date: May 25, 2006

(54) Record transfer system

(76) Inventors: Ron Rieger, Camarillo, CA (US); Scott Hillman, Port Hueneme, CA (US); John Reese, Los Angeles, CA (US)

Correspondence Address: SoCAL IP LAW GROUP LLP, 310 N. WESTLAKE BLVD. STE 120, WESTLAKE VILLAGE, CA, 91362, US

(21) Appl. No.: 10/995,929

(22) Filed: Nov. 22, 2004

(51) Int. Cl. G06F 17/30

(52) U.S. Cl. 707/200

(57) ABSTRACT

Record transfer is described herein. A method includes providing a software component to a record holder computer. The record holder computer may receive a request from a record transfer server to transfer a record from the record holder to the record transfer server. The software component may, in response to a user interaction, prepare a first version of the record and upload the first version of the record to the record transfer server. The software component may automatically and may regularly prepare a first version of one or more records and upload them to the record transfer server. The record transfer server may extract at least some material data included in the first version of the record. The record transfer server may store the material data. The software component may be a virtual printer driver, an application plug-in or other software.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to the capture, network transfer, and extraction of data from records.

2. Description of the Related Art

In numerous business applications information generated by an existing software application, the first software application, running in one computer system is placed in a final form such as being printed or stored as a portable document format (PDF) file. However, subsequent to fixing the information in a final form, the some or all of the information may need to be input into another computer system for a different software application, the second software application.

It is frequently difficult to modify the first software application that originally generated the information to enable the software application to digitally provide the information needed to satisfy the requirements of the second application.

For example, high school students apply to colleges, for jobs, and for scholarships. College students apply to graduate schools, for scholarships, and for jobs. Colleges and graduate schools typically require official transcripts as part of an application to the school. Similarly, employers and scholarship providers typically require official transcripts as well. The application software responsible for generating and printing transcripts is typically part of a school's Student Information System (SIS). It is difficult to modify SIS software to enable it to provide a variety of digital versions of transcripts, or other student records, to satisfy the desires of the different software applications running in computer systems at colleges used to evaluate student transcripts for admissions. Traditionally, colleges spend time and money to manually reenter much of the information contained on received printed student transcripts. The same can be said for some employers and scholarship providers.

In another example, automobile dealers, use a dealer management system (DMS) to manage the process of finding and funding auto loans for customers. Typically, the DMS software applications print the documents required for funding loans and the dealers mail the loan documents to selected financial institutions. The financial institutions, at significant expense manually reentered information from the loan documents into the financial institution's computers so that the financial institutions can evaluate and process the loan.

### DESCRIPTION OF THE DRAWINGS

FIG. 1 is a block diagram of an environment of a record transfer system.

FIG. 2 is a flow chart of the actions taken by a record transfer system server.

### DETAILED DESCRIPTION OF THE INVENTION

Throughout this description, the embodiments and examples shown should be considered as exemplars, rather than limitations on the invention.

Systems

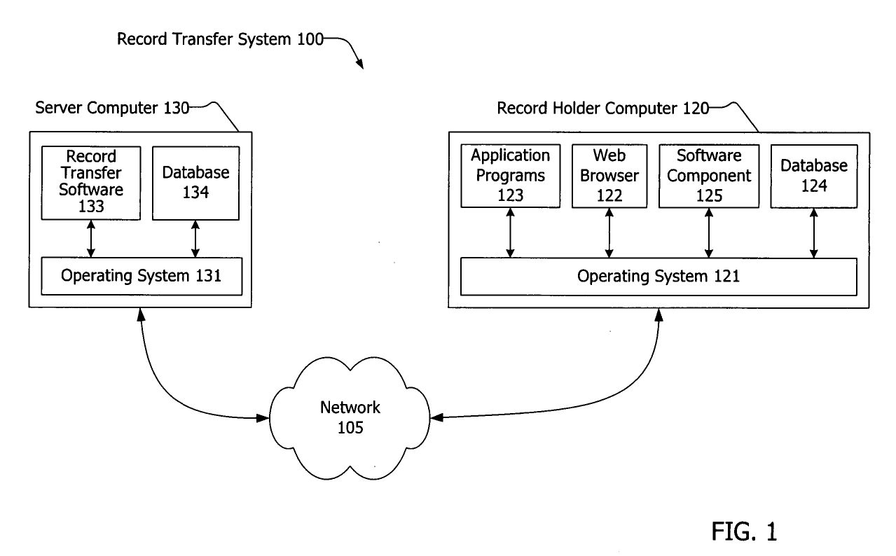

Referring now to FIG. 1, FIG. 1 is a block diagram of an environment for the record transfer system 100. The record transfer system 100 may include a record holder computer 120, a server computer 130, and a network 105.

As used herein, a record is a document or file that includes information. A record may be in electronic or hard copy format, may be printed on paper, viewable on a display and/or stored on a machine readable medium. Records include, for example, without limitation, school transcripts, medical information, loan documents, and property purchase transactional documents.

In one embodiment, the record transfer system 100 may be used to facilitate the transfer of school transcripts from a school using or accessing a record holder computer 120 to the record transfer server 130. The server computer 130 may create and manage a database of student records. The eventual recipient of the information contained in the records may be another school or to a potential employer. The student records on the server computer 130 may be used by colleges, including graduate schools, to prospect for potential candidates for admission.

In another embodiment, the record transfer system 100 may be used to facilitate transfer of any confidential records to the record transfer server 130. In this embodiment, the records may contain confidential information about a job applicant, a school applicant, a loan applicant, a property owner or purchaser, a car buyer, a medical patient, and others. In this embodiment, the record holder using or accessing record holder computer 120 may be a medical doctor, a medical care provider, a hospital, an insurance company, a bank, a financial institution, a school, a credit agency, a government agency or other person or entity. In this embodiment, the eventual recipient of the information contained in the records and stored on the record transfer server 130 may be a potential employer, a bank, a hospital, an insurance company, a title company, a lender, a seller, an automobile dealership, or other person or entity.

The hardware and software of the record transfer system 100 and its functions may be distributed such that some aspects are performed by each of the record holder computer 120 and the server computer 130. Because the record transfer server 130 may be required to keep records confidential and to receive and transmit information securely, communications between the record holder computer 120 and the record transfer server 130 may be over secure links. In another embodiment, the record holder computer 120 and the server computer 130 may communicate using regular or not secure connections, and the files transmitted between the entities may be separately encrypted and decrypted.

Although only one each of the record holder computer 120 and the server computer 130 are depicted in FIG. 1, the record transfer system 100 may include one or more of each of the record holder computer 120 and the server computer 130.

The network 105 may include or be one or more of a local area network (LAN), a wide area network (WAN), a storage area network (SAN), or a combination of these. The network 105 may include or be the Internet. The network 105 may be wired, wireless, or a combination of these, and may include or be augmented by satellite communications. The network 105 may be public or private, or a combination of public and private. The network 105 may be comprised of numerous nodes providing numerous physical and logical paths for data to travel. The network 105 may support one or more well known, proprietary, and other communications protocols, including, for example, Ethernet, the hyper-text transfer protocol (HTTP), the file transfer protocol (FTP), the User Datagram Protocol (UDP), the transmission Control Protocol (TCP), the Internet Protocol (IP), and others. The network 105 may also support secure communications protocols such as, for example, secure HTTP (S-HTTP) and Secure Sockets Layer (SSL).

The record holder computer 120 and the record transfer server 130 may each be a server computer or personal computer and may be a combination of computers in a group, such as a LAN or cluster. The record holder computer 120 and the record transfer server may each be one or more other types of computing devices such as personal computers and server computers. The term computing device as used herein is not limited to server computers and personal computers but refers to any device with a processor, a memory, a storage device, and a network communications unit. The network communications unit allows for communications over network 105 and may support one or more communications protocols, such as, for example, Ethernet, and others. The term computing device includes, but is not limited to, personal computers, server computers, computing tablets, computer workstations, set top boxes, video game systems, personal video recorders, telephones, personal digital assistants (PDAs), portable computers, and laptop computers. These computing devices may run an operating system, including, for example, the Microsoft Windows, Linux, Unix, MS-DOS, Palm OS, and the Apple Mac OS X operating systems. The operating system may include network communications software that allows for communication over the network 105. The network communications software may provide support for communications according to protocols such as UDP, TCP, IP and others. The network communications software may provide support for wired and/or wireless network communications.

A record owner is a person who has ownership of the information contained in the record and may have exclusive control over access to and dissemination of the information contained in the record. The record owner may be the person about whom the record contains information. In another embodiment, the record owner is the person who owns property described in the record. In yet another embodiment, the record owner is a person involved in a transaction, contract or other relationship, personal or business, described in the record. Records as used herein include high school and college transcripts, and may also include loan documents, bank statements, credit card bills, business contracts, notes of indebtedness, deeds, titles, licenses, assignments, certificates, and others.

A record holder is an entity that stores and controls access to a record associated with a record owner. Record holders include schools such as high schools, colleges and universities, and may also include banks, financial institutions, insurance companies, doctors, automobile dealers, real estate companies, lawyers, accountants, government agencies or departments (local, state and federal), and others.

The record holder computer 120 may include a web browser 122, an application program 123, a software component 125 provided by the record transfer system, and a database 124. The web browser 122 may enable the record holder to interact and communicate with the server computer 130 over the network 105. The application programs 123 may be an email client, a messenger program, and other application programs. The database 124 may maintain records associated with record owners. The database may be associated with an application program 123 running on the record holder, such as, for example, specialized student information system (SIS) programs and transcript programs used by schools.

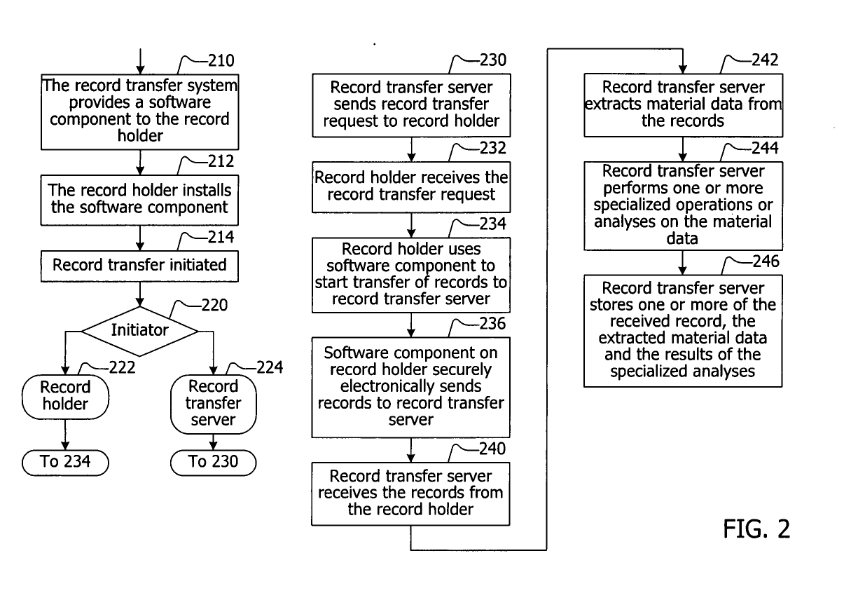

The record holder computer 120 may include the software component 125 for providing some of the functionality and features of the record transfer system described herein and described below regarding FIGS. 2 and 3. The software component 125 may include or be one or more of an application program, a driver, an applet (e.g., a Java applet), a browser plug-in, a COM object, a dynamic linked library (DLL), a script, one or more subroutines, or an operating system component or service. More specifically, the software component 125 may be implemented as a printer driver, as a plug-in to an application program, such as, for example an SIS or DMS application, as a Java applet, as an Internet browser plug-in, or using other software programming techniques. The software component 125 may create a printer file format version of one or more records from the database 124 and transmit the printer file format version of the records to the server computer 130. The software component 125 may preprocess and/or preformat one or more records from the database 124. The software component 125 may send one or more records to the server computer 130.

The software component 125 and other software included with the record holder computer 120 may be stored on a machine readable medium and accessed by a storage device or directly by a processor. Machine readable media include, for example, magnetic media such as hard disks, floppy disks and tape; optical media such as compact disks (CD-ROM and CD-RW) and digital versatile disks (DVD and DVD±RW); flash memory cards; and any other machine readable media. As used herein, a storage device is a device that allows for reading and/or writing to a machine readable medium. Storage devices include hard disk drives, DVD drives, flash memory devices, and others.

The server computer 130 may include an operating system 131, record transfer software 133, and a database 134. The database 134 may be, as shown, a separate program from record transfer software 133 or may be included in record transfer software 133. The record transfer software 133 may be stored on a machine readable medium and accessed by a storage device or directly by a processor. The server computer 130 may interact with and communicate with the record holder computer 120 via the network 105. The record transfer software 133 and the software component 125 may operate in conjunction to implement the method described below in FIG. 2.

The Methods

Referring now to FIG. 2, FIG. 2 is flow chart of the actions taken by a record transfer system. The actions described in FIG. 2 may be achieved by software in the form a software component 125 and an application program such as record transfer software 133 described above. Actions ascribed to the “record transfer system server” or the “server” in the discussion of FIG. 2 may be carried out by software such as the record transfer software 133. Actions ascribed to the “record holder” maybe carried out by software such as the software component 125.

The record transfer system provides a software component to the record holder, as shown in block 210. This may be achieved by a record holder downloading the software component from the record transfer system server, by the record transfer system providing a CD containing the software component to the record holder, or through some other delivery technique. The record holder installs the software component on the record holder computer, as shown in block 212.

A record transfer of one or more records from the record holder to the record transfer server may then be initiated, as shown in block 214. The record transfer may be initiated by either the record transfer server or the record holder. The flow of actions continues based on the initiator, as shown in block 220. If the record transfer is requested by the record transfer server, as shown in block 224, the flow of actions continues at block 230.

The record transfer server may request one or more records from the record holder, as shown in block 230. The request made by the record transfer server may be referred to as a record transfer request. The record transfer request may be regularly made by the record transfer server to obtain newly stored records from the record holder. The record transfer request may be made, for example, daily, weekly, monthly, quarterly, and at other intervals. The record may be a student transcript, a loan document, bank statement, loan statement, a medical file or document, property title, credit report, or other information requiring secure delivery.

In addition or in the alternative, the server may allow a user, such as, for example, a record owner, to request that a record be transferred from the record holder to the record transfer server. The request made by the user may be referred to as a user request. The user request may trigger a record transfer request. To receive a user request, the record transfer server may provide a graphical user interface via a web page using, for example, text entry fields, forms, button, pull down menus, check boxes and other graphical user interface items. The server software may provide a list of participating record holders from which a user may select using the provided graphical user interface. In this embodiment, the user may select from participating record holders in preparing the user request. The user may be a record owner. The user request may be received by software running on the record transfer system server. The user request may be for the software on server 130 to transfer a record from the record holder computer 120. The server may provide a secure connection with the record owner's computer via a web browser to receive the record transfer request over the network over a secure connection. This may be achieved, for example, using S-HTTP and/or SSL.

The server may send a record transfer request to the record holder via a secure connection over the network. The request may be for all newly updated records. The request may be for one or more specific records and may include record owner identifying information or record subject identifying information. The record owner identifying information may include one or more of a record owner name, a record owner address, a record owner identification number such as, for example, a social security number, a student identification number, a bank account number. The record subject identifying information may include a property address, a vehicle identification number (VIN), a bank account number, a loan account number, and/or other information. The request may include the type and or other identifying information concerning the record requested. For example, the record requested may be a student transcript from years 2000 through 2003, a credit card history from years 1998-2002, a current bank statement, a current loan statement, or an employment record from 2003.

In one embodiment, the server may send an email note to a designated email address at the record holder instructing the record holder to click on a provided link to a secure website provided by the server. In response to receiving an email note, the record holder may access the server website to view the record transfer request. In another embodiment, a record holder may regularly log into a record holder account at a website provided by the server, and the server may provide a message via a pop-up window of the record holder that a record request is pending. Alternatively, the record holder may check a record request status page to learn whether any new user requests have been received.

The record holder receives the record transfer request, as shown in block 232. The record holder may send an acknowledgement to the server that the request for the record has been received. The request may be made between software executing on a server computer and software executing on a record holder computer. The software on the server may communicate with software on the record holder which automatically acknowledges receipt of the record request without human intervention. The server may receive the acknowledgement from the record holder that the request for the record has been received. The communications between the server computer and the record holder computer maybe secure.

The record transfer server may request that the record holder accept or deny the request for the record. In this way, the record holder may decide to accept or deny the request for the record and inform the record transfer server of the decision. This functionality may be provided by the record transfer server to the record holder via a user interface on a web page.

The record holder may determine whether it is has the requested record. If the record holder does not have the requested record or records, the record holder may notify the record transfer server that it cannot service the record transfer request. The flow of action continues with block 234.

When the record transfer is record holder initiated, as shown in blocks 220 and 222, the flow of actions proceeds beginning with block 234. The record holder may periodically upload groups or batches of records to the server. By performing record holder initiated group or batch uploads, the record holder's resources may be utilized more efficiently, in that the record holder may choose when to most efficiently upload records to the record transfer server.

The record holder uses the software component to start transfer of the record or records to the record transfer server, as shown in block 234. The software component on the record holder securely electronically sends the record or records to the record transfer server, as shown in block 236. Secure transfer of the record may be achieved using a secure communications protocol. Secure transfer of the record may also be achieved by encrypting the record before transferring the record over an insecure communications protocol.

The record holder may send the record as an electronic file. The electronic file may be: (1) in a printer file format such as, for example, a page description language (PDL) including printer control language (PCL) and PostScript; (2) in a readily viewable and printable format such as portable document format (PDF) or Microsoft Word format; (3) a text based file; (4) formatted using a markup language such as the extensible markup language (XML), the Standard Generalized Markup Language (SGML) and the hypertext markup language (HTML); (5) a comma separated variable (CSV) format file; (6) a spreadsheet formatted file such as Microsoft Excel; (7) a proprietary format; or (8) an other file format. As used herein a printer file format is a file format that is required by a printer and may be directly processed by a printer. A printer file format specifies the arrangement of a printed page through commands from a computer to a printer. Printer file formats include PDLs, PCL, and PostScript.

The record transfer may be initiated by the record holder printing one or more records from a SIS software program or other application program. The record holder may select as a printer the “record transfer system.” The record transfer system may provide a software component containing a printer driver to the record holder. In one embodiment, the software component takes the record to be printed and transfers the record to the record transfer system server in a printer file format or other electronic file format. In another embodiment, the software component takes the record to be printed, performs some processing on or preformats the record, as described below, and transfers the record to the record transfer system server as an electronic file. As such, the “record transfer system” printer driver is a faux printer driver that serves as a network communication transfer driver. The faux printer driver may encrypt the records before transferring the records to the server. Using other terminology, the faux printer driver is a printer driver to a virtual printer in which the record transfer system is the virtual printer.

The record or records to be transferred may be preformatted. That is, the software component may, before transferring the records, preprocess the records to conform to preformatting requirements of the record transfer system. The preprocessing may be performed to preformat the records to conform with a format desired or required by the record transfer software on the server.

In one embodiment, the faux printer driver version of the software component may prepare a PCL or other printer file format version of the record and process it to prepare a preformatted record. In another embodiment, the record may be preformatted by a plug-in version of the software component that operates in conjunction with an application program on a record holder computer, such as, for example, SIS or DMS software, to conform with a format desired or required by the record transfer software on the server.

The preformatted record may include formatting information and material data. Formatting information is information which describes where and how the material data should be displayed on a screen or in a print copy. Formatting information may include location information which describes where the material data is located. Formatting information may include font or typeface information, included graphics, and other characteristics and features used in displaying or printing the record. Material data is substantive information. For example, if the record is a student transcript, material data may include the student's name, social security number, grade point average (GPA), class names, grades, address, school name, and other information. If the record is a loan document, material data may include the record owner's name, social security number, loan amount, property information such as a street address or vehicle identification number, date of origin of the loan, loan company name, loan company address, and other information.

In one embodiment, the preformatting requirements may involve providing a record with location information and material data. The location information may be in the form of (X, Y) coordinates describing where in the record the material data is located. The location information may be in pixels, inches, or other measurement technique. The location information may include offsets or other positioning information. The preformatted record may be created in XML format. When a faux printer driver version of the software component is used, the preformatted record file may be prepared by extracting material data from a PCL or other printer file format version of a record and preparing location information concerning each of the material data.

The records may be received at the record transfer server from the record holder, as shown in block 240. The records may be received as one or more electronic files, in a printer file format, and/or in preformatted or other format. Upon receiving the record or records, the server may store the record or records, such as in a database. In one embodiment, the server decrypts the received record or records before storing. If the received record is preformatted, the received record may include formatting information and material data. The server may extract material data from the record, as shown in block 242. The server may store the material data extracted from the record in a database along with or in place of the received record.

The server may perform one or more specialized operations or analyses on the material data, as shown in block 244. Specialized operations and analyses include normalizing extracted material data, mapping extracted material data, preparing a ranking of the student based on the original and/or normalized material data, and other operations and analyses. The specialized operations and analyses may be used to transform the record into a desired format.

Normalization is the process of modifying the numerical material data to conform to a standard. In one embodiment, for example, at least one datum of the material data may be normalized, such as, a GPA, some or all grades, and others. For example, in greater detail, if the standard GPA of high schools is on a 4.0 scale, then a GPA of 4.5 on a 5.0 scale may be normalized to a 3.6. The normalization may take into consideration grading curves that differ between schools in addition to differing grading scales, as well as other differences. In another embodiment, credit scores or other financial ranking may be normalized to conform to a standard.

Mapping is the process of modifying textual material data to conform to a standard. In one embodiment, mapping may be performed, for example, on class names. For example, if the standard name for 9^{th} grade English is “English 100”, then a 9^{th} grade English class with a title “English 232” or “Freshman English” may be mapped to “English 100.” Numerical codes may also be used in the mapping such that all of the classes of all schools are mapped to a uniform class coding scheme used by the record transfer server via a mapping key that may be created for each school. Each record may be mapped based on the coding scheme and mapping key for the record holder school. In another embodiment, the name of a financial institution account or loan may be mapped from a proprietary or custom name to a standardized name. For example, a “sure saver account” maybe mapped to a “savings account.”

The server may also rank all records based on a proprietary analysis, based on an algorithm provided by a third party, and according to other techniques. In one embodiment, the ranking may take into consideration a difficulty level of a class or department, a competitiveness ranking of the record holder school, normalized and/or original grades, normalized and/or original GPA, and other factors. In another embodiment, the ranking may take into consideration credit score, account balances, debt load and other factors.

Normalization and mapping may be performed in combination to modify records to a common standard. All records be normalized and/or mapped and/or ranked and then saved in a database. The server may store the specially processed record in addition to or in place of the record received from the record holder. The record transfer server may store one or more of the received record, the extracted material data and the results of the specialized analyses in a database, as shown in block 246.

With regard to FIG. 2, additional and fewer steps may be taken, and the steps as shown may be combined or further refined to achieve the methods described herein.

Although exemplary embodiments of the present invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

1. A method comprising:
providing a software component to a record holder computer
the record holder computer receiving a request over a network from a record transfer server to transfer a record from the record holder to the record transfer server
the software component in response to a user interaction preparing a first version of the record and uploading the first version of the record to the record transfer server
the record transfer server extracting at least some material data included in the first version of the record
the record transfer server storing the material data.

2. The method of claim 1 wherein the software component is used in conjunction with a software application program earlier installed on the record holder computer.

3. The method of claim 2 wherein the software application is a dealer management system software program.

4. The method of claim 2 wherein the software application is a student information system software program.

5. The method of claim 2 wherein the software component is a virtual printer driver.

6. The method of claim 1 wherein the first version of the record is a preformatted version of the record.

7. The method of claim 1 wherein the first version of the record includes the material data and location information.

8. The method of claim 7 wherein the location information is in the form of X,Y coordinates.

9. The method of claim 1 wherein the first version of the record is in a markup language.

10. The method of claim 1 wherein the first version of the record is a printer file format version of the record.

11. The method of claim 1 wherein the first version of the record comprises a format selected from the group comprising printer control language (PCL), PostScript, and portable document format (PDF).

12. The method of claim 1 wherein the network is the Internet.

13. The method of claim 1 wherein the uploading is performed securely over the network.

14. A method comprising:
providing a printer driver to a record holder
the record holder computer receiving a request over a network from a record transfer server to transfer a record from the record holder to the record transfer server
the record holder using the printer driver to prepare a first version of the record and to send the record to the record transfer server
the record transfer server extracting at least some material data included in the first version of the record
the record transfer server storing the material data.

15. The method of claim 14 wherein the first version of the record is a preformatted version of the record.

16. The method of claim 14 wherein the first version of the record includes material data and location information.

17. The method of claim 16 wherein the location information is in the form of X,Y coordinates.

18. The method of claim 14 wherein the first version of the record is in a markup language.

19. The method of claim 14 wherein the first version of the record is a printer file format version of the record.

20. The method of claim 14 wherein the first version of the record comprises a format selected from the group comprising printer control language (PCL), PostScript, and portable document format (PDF).

21. The method of claim 14 further comprising:
the record holder notifying the record transfer server of the status of the request.

22. The method of claim 14 wherein the record transfer server storing the material data comprises:
saving the material data in a database.

23. A method comprising:
providing a software component to a record holder computer
the software component either in response to a user interaction or automatically preparing a first version of one or more records stored by the record holder computer
the software component uploading the first version of the one or more records to the record transfer server
the record transfer server extracting at least some material data included in the first version of the record
the record transfer server storing the material data.

24. The method of claim 23 wherein the software component is used in conjunction with a software application program earlier installed on the record holder computer.

25. The method of claim 24 wherein the software application is a dealer management system software program.

26. The method of claim 24 wherein the software application is a student information system software program.

27. The method of claim 24 wherein the software component is a virtual printer driver.

28. The method of claim 23 wherein the first version of the record is a preformatted version of the record.

29. The method of claim 23 wherein the first version of the record includes the material data and location information.

30. The method of claim 29 wherein the location information is in the form of X,Y coordinates.

31. The method of claim 23 wherein the first version of the record is in a markup language.

32. The method of claim 23 wherein the first version of the record is a printer file format version of the record.

33. The method of claim 23 wherein the first version of the record comprises a format selected from the group comprising printer control language (PCL), PostScript, and portable document format (PDF).

34. The method of claim 23 wherein the network is the Internet.

35. The method of claim 23 wherein the uploading is performed securely over the network.
